(19) United States
(12) Patent Application Publication
(10) Pub. No.: US 2023/0076302 A1
(43) Pub. Date: Mar. 9, 2023

(54) COMPUTER-READABLE RECORDING MEDIUM HAVING STORED THEREIN CONTROL PROGRAM, INFORMATION PROCESSING APPARATUS, AND METHOD FOR CONTROLLING

(71) Applicant: FUJITSU LIMITED, Kawasaki-shi (JP)

(72) Inventors: HIROKI OHTSUJI, Yokohama (JP); Eiji Yoshida, Yokohama (JP)

(73) Assignee: FUJITSU LIMITED, Kawasaki-shi (JP)

(21) Appl. No.: 17/830,390

(22) Filed: Jun. 2, 2022

(30) Foreign Application Priority Data
Sep. 6, 2021 (JP) 2021-144552

(51) Int. Cl. G06F 9/54; G06F 11/34

(52) U.S. Cl. CPC G06F 9/544; G06F 11/3409

(57) ABSTRACT

A computer readable recording medium having stored therein a control program that causes a computer to execute a process including: when an application transmits an IO request, determining whether to execute a process before the application receives a completion response of an IO process to the IO request instead of executing the process after the completion response, based on a first and second indicators, the first indicator relating to a performance decline ratio when the process is executed before the completion response, the second indicator relating to a performance decline ratio when a snapshot of a memory region at a time point that the IO request is transmitted is generated, the memory region storing an execution code of the application; and when determining to execute the process before the completion response, generating the snapshot of the memory region, and causing the application to start execution of the process.

### CROSS-REFERENCE TO RELATED APPLIO ATION

This application is based upon and claims the benefit of priority of the prior Japanese Patent application No. 2021-144552, filed on Sep. 6, 2021, the entire contents of which are incorporated herein by reference.

### FIELD

The embodiment discussed herein is directed to a computer-readable recording medium having stored therein a control program, an information processing apparatus, and a method for controlling.

### BACKGROUND

In an IO (Input-Output) process between computers exemplified by an IO process from a client node (hereinafter simply referred to as a “client”) to a server, a synchronous IO process is executed to simplify a program on the client side. In the following description, the IO process is assumed to be a writing process.

A synchronous IO process is a scheme in which a client program suspends an operation until receiving an IO response indicating the result of an IO process from the server (in other words, until writing to the server is guaranteed) after issuing an IO request and resumes the operation according to the contents of the IO response.

[Patent Document 1] Japanese Laid-open Patent Publication No. 2000-285082

[Patent Document 2] Japanese National Publication of International Patent Application No. 2006-518077

[Patent Document 3] U.S. Patent Application Publication No. 2004/0162948

In a synchronous IO process, for example, when the time from an issue of an IO request from a client program to reception of an IO response at the client program (waiting time for response with IO completion) increases, the program stopping time is prolonged by the increased waiting time for response.

In order to shorten the processing time of a synchronous IO process, for example, it is assumed that a client-side program performs, during a synchronous IO process, a speculative process that speculatively executes a process after issuing an IO request without waiting for the completion of the IO process on the server side.

In one example of a speculative process, in preparation for a failure of an IO process on the server side, the client records the state of a storing region of a memory at the time point of the start of the speculative process, for example, capturing a snapshot (SS; Snap Shot) of a duplicate of the contents of the storing region of the memory. With this configuration, when the IO process fails on the server side, the client can perform a restoring process to restore (rewind) the storing region of the memory to a state before the execution of the speculative process from the SS.

However, due to various factors, the generation time of a SS and the restoring process time from the SS in a speculative process sometimes becomes longer than the waiting time of response of an IO completion (the IO time by the writing guarantee), in other words, exceeds the merit of the speculative process in some cases. Examples of the various factors include the content of a synchronous IO process, the loading status of the client, the server, the network, and the like.

Further, as the size of the storing region of a memory (in other words, the region of a target to capture a SS) that the program can use increases, the capturing cost, such as the capacity of a storing region for storing the SS and the generation time of the SS, increases. Further, since the storing region is occupied by the SS, the processing performance (processing speed) of the client is lowered, and the processing time of the synchronous IO process may be delayed.

As described above, in the assumed synchronous IO process, the speculative process for shortening the processing time is sometimes not appropriate.

### SUMMARY

According to an aspect of the embodiments, a non-transitory computer readable recording medium has been stored therein a control program that causes a computer to execute a process including: when an application transmits an input-output (IO) request, determining whether or not to execute a first process before the application receives a completion response of an IO process to the IO request instead of executing the first process after the application receives the completion response, the determining being based on a first indicator and a second indicator, the first indicator relating to a performance decline ratio when the first process is executed before the application receives the completion response, the second indicator relating to a performance decline ratio when a snapshot of a memory region at a time point that the IO request is transmitted is generated, the memory region storing an execution code of the application; and when determining to execute the first process before the application receives the completion response, generating the snapshot of the memory region, and causing the application to start execution of the first process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a system according to one embodiment;

FIG. 2 is a block diagram illustrating an example of a hardware (HW) configuration of a computer that achieves the function of a client according to the one embodiment;

FIG. 3 is a block diagram illustrating an example of a functional configuration of the system of the one embodiment;

FIG. 4 is a diagram illustrating an example of comparing a synchronous IO process and a speculative IO process;

FIG. 5 is a diagram illustrating an example of a speculative process execution time table;

FIG. 6 is a diagram illustrating an example of a non-speculative process execution time table;

FIG. 7 is a diagram illustrating an example of an execution time table when a SS memory is reserved;

FIG. 8 is a diagram illustrating an example of an average writing time table;

FIG. 9 is a diagram illustrating an example when a speculative IO process is aborted;

FIG. 10 is a diagram illustrating an example when a speculative IO process is suppressed; and

FIG. 11 is a flow diagram illustrating an example of operation of a client.

### DESCRIPTION OF EMBODIMENT(S)

Hereinafter, an embodiment of the present invention will now be described with reference to the drawings. However, the embodiment described below is merely illustrative, and there is no intention to exclude application of various modifications and techniques that are not explicitly described below. For example, the present embodiment can be variously modified and implemented without departing from the scope thereof. In the drawings used in the following embodiment, the same reference symbols denote the same or similar parts, unless otherwise specified.

### <1> One Embodiment

<1-1> Example of System Configuration:

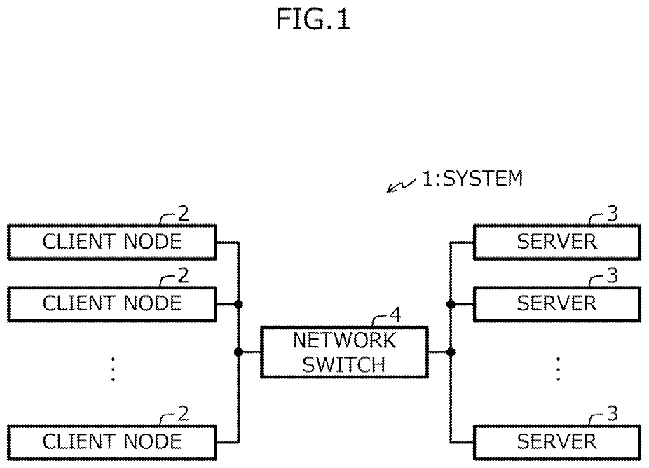

FIG. 1 is a block diagram illustrating an example of a configuration of a system 1 according to one embodiment. The system 1 includes multiple computers among which a synchronous IO process may be executed.

The following description assumes an example of a synchronous IO process between computers is an IO process (e.g., writing process) from a client node 2, which is an example of a writing-source computer, to a server 3, which is an example of a writing-destination computer, but the IO synchronous process is not limited to this. The method according to the one embodiment may be applied to various synchronous IO process, e.g., an IO process between nodes in a parallel computing system or the like.

As illustrated in FIG. 1, the system 1 may illustratively include multiple client nodes (clients) 2, multiple servers 3, and a network switch 4. Each of the multiple clients 2 and the multiple servers 3 is an example of a computer or an information processing apparatus. The network switch 4 is a device for communicably connecting the multiple clients 2 and the multiple servers 3 to one another via a network. Examples of the network may include a Local Area Network (LAN) and/or the Internet.

<1-1-1> Example of Hardware Configuration:

The client 2 according to the embodiment may be a physical server or a virtual server (Virtual Machine (VM)). The functions of the server 2 may be achieved by one computer or by two or more computers. Further, at least some of the functions of the client 2 may be implemented using Hardware (HW) resources and Network (NW) resources provided by cloud environment.

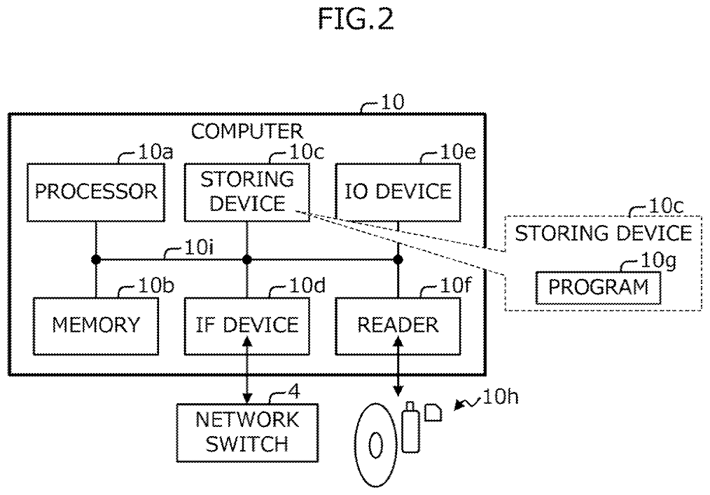

FIG. 2 is a block diagram illustrating an example of the hardware (HW) configuration of a computer 10 that achieves the functions of the client 2 according to the embodiment. If multiple computers are used as the HW resources for achieving the functions of the client 2, each of the computers may include the HW configuration illustrated in FIG. 2.

As illustrated in FIG. 2, the computer 10 may illustratively include a HW configuration formed of a processor 10a, a memory 10b, a storing device 10c, an IF (Interface) device 10d, an IO (Input/Output) device 10e, and a reader 10f.

The processor 10a is an example of an arithmetic operation processing device that performs various controls and calculations. The processor 10a may be communicably connected to the blocks in the computer 10 via a bus 10i. The processor 10a may be a multiprocessor including multiple processors, may be a multicore processor having multiple processor cores, or may have a configuration having multiple multicore processors.

The processor 10a may be any one of integrated circuits (ICs) such as Central Processing Units (CPUs), Micro Processing Units (MPUs), Graphics Processing Units (GPUs), Accelerated Processing Units (APUs), Digital Signal Processors (DSPs), Application Specific Integrated Circuits (ASICs), and Field Programmable Gate Arrays (FPGAs), or combinations of two or more of these ICs.

The memory 10b is an example of a HW device that stores various types of information such as various data pieces and programs. Examples of the memory 10b include one or both of a volatile memory such as a Dynamic Random Access Memory (DRAM) and a non-volatile memory such as Persistent Memory (PM).

The storing device 10c is an example of a HW device that stores information such as various data pieces and programs. Examples of the storing device 10c include a magnetic disk device such as a Hard Disk Drive (HDD), a semiconductor drive device such as a Solid State Drive (SSD), and various storing devices such as a nonvolatile memory. Examples of the nonvolatile memory include a flash memory, a Storage Class Memory (SCM), and a Read Only Memory (ROM).

The storing device 10c may store a program 10g (control program) that implements all or part of various functions of the computer 10.

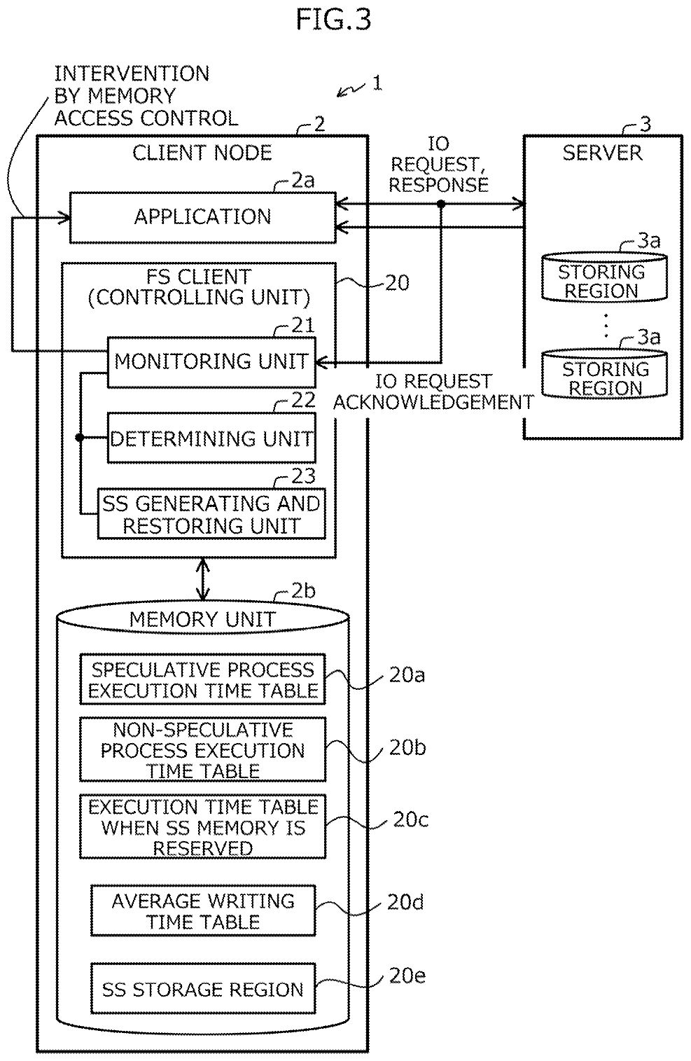

For example, the processor 10a of the client 2 can achieve the functions of the client 2 (for example, an FS client 20 illustrated in FIG. 3) to be detailed below by expanding the program 10g stored in the storing device 10c onto the memory 10b and executing the expanded program 10g.

The IF device 10d is an example of a communication IF that controls connection and communication with one or the both of the networks including a network between a client 2 and multiple servers 3 or another client 2. For example, the IF device 10d may include an applying adapter conforming to Local Area Network (LAN) such as Ethernet (registered trademark) or optical communication such as Fibre Channel (FC). The applying adapter may be compatible with one of or both wireless and wired communication schemes.

For example, the client 2 may be communicably connected to each of the multiple servers 3 and another client 2 via IF device 10d and the network. Furthermore, the program 10g may be downloaded from the network to the computer 10 through the communication IF and be stored in the storing device 10c.

The IO device 10e may include one or both of an input device and an output device. Examples of the input device include a keyboard, a mouse, and a touch panel. Examples of the output device include a monitor, a projector, and a printer. The IO device 10e may be include, for example, a touch panel that integrates an input device and an output device.

The reader 10f is an example of a reader that reads information of data and programs recorded on a recording medium 10h. The reader 10f may include a connecting terminal or device to which the recording medium 10h can be connected or inserted. Examples of the reader 10f include an applying adapter conforming to, for example, Universal Serial Bus (USB), a drive apparatus that accesses a recording disk, and a card reader that accesses a flash memory such as an SD card. The program 10g may be stored in the recording medium 10h. The reader 10f may read the program 10g from the recording medium 10h and store the read program 10g into the storing device 10c.

The recording medium 10h is an example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is exemplary. Accordingly, the computer 10 may appropriately undergo increase or decrease of HW devices (e.g., addition or deletion of arbitrary blocks), division, integration in an arbitrary combination, and addition or deletion of the bus. For example, the computer that achieves the server 3 may be similar in hardware configuration to the above computer 10.

<1-1-2> Example of Functional Configuration:

Next, description will now be made in relation to an example of a functional configuration (software configuration) of the system 1 according to the one embodiment. FIG. 3 is a block diagram illustrating an example of the functional configuration of the system 1 according to the one embodiment. One client 2 and one server 3 illustrated in FIG. 1 appears in FIG. 3, and illustration of the remaining clients 2, the remaining servers 3, and the network switch 4 is omitted.

As illustrated in FIG. 3, the client 2 may illustratively include an application 2a, a memory unit 2b, and a file system (FS; File System) client 20.

For example, the client 2 may execute an application 2a that performs a synchronous IO process, such as a synchronous writing process, to be performed on the storing region 3a of the server 3. The application 2a is a variety of programs executed by the client 2.

The FS client 20 is a program that relays (passes) an IO request and a response between the application 2a and the server 3 and also that controls the file system (FS) of the client 2 exemplified by a storage, and is an example of a controlling unit. The FS client 20 controls the application 2a such that the server 3 is treated as a local storage of the client 2 and, in the one embodiment, controls the execution of a speculative process by the application 2a in a synchronous writing process.

In the following description, a synchronous IO (writing) process is assumed to be a series of processing being executed by the application 2a and including an IO request to the server 3. A speculative process is processing that is executed by the application 2a after the issuance of the IO request in the synchronous IO process and can be executed without waiting for the reception of a completion response from the server 3 to the IO request. Furthermore, a speculative IO process is one type of the synchronous IO process, and refers to a synchronous IO process including execution of a speculative process.

For example, the FS client 20 according to the one embodiment can cause the application 2a to execute speculative process by intervening in the application 2a via the memory access control in a synchronous writing process.

The memory unit 2b is an example of a storing region and stores various data used by the FS client 20. The memory unit 2b may be achieved by, for example, a storing region that one or both of the memory 10b and the storing device 10c illustrated in FIG. 2.

As illustrated in FIG. 3, the memory unit 2b may, by way of example, be capable of storing a speculative process execution time table 20a, a non-speculative process execution time table 20b, an execution time table 20c when a SS memory is reserved, and an average writing time table 20d, and may include a SS storage region 20e. Hereinafter, for the sake of convenience, each of the information 20a to 20d that the memory unit 2b stores is expressed in a table format, but the form of the information is not limited to this. At least one of the information 20a to 20d that the memory unit 2b stores may be in various formats such as a database (DB) or an array.

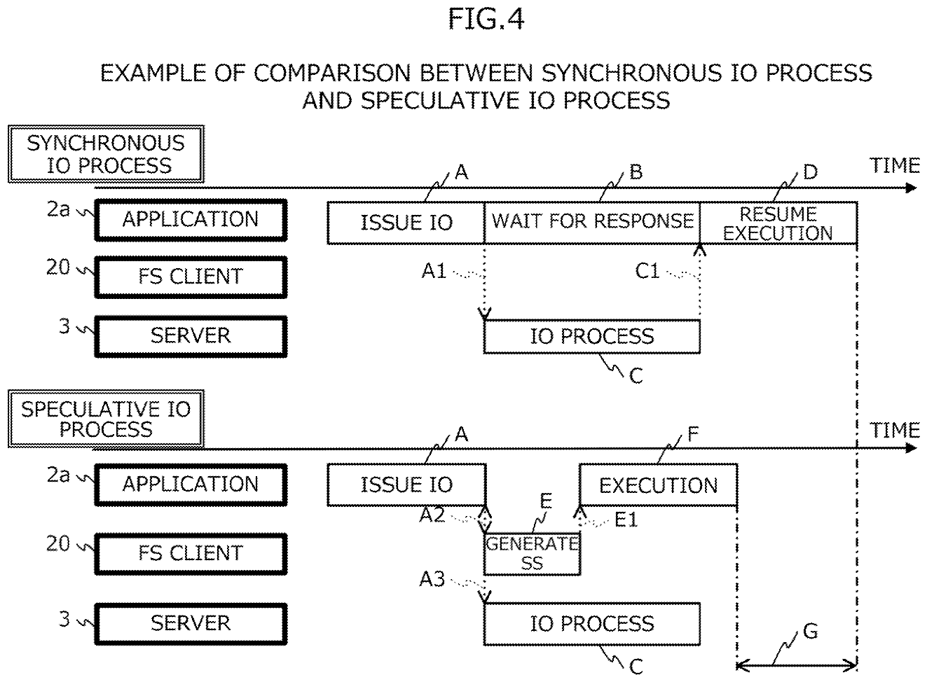

Next, description will now be made in relation to a synchronous IO process and a speculative IO process. FIG. 4 is a diagram illustrating an example of comparing a synchronous IO process and a speculative IO process. The upper part of FIG. 4 illustrates an example of a synchronous writing process when a speculative process is not executed as a synchronous IO process. The lower part of FIG. 4 illustrates an example of a process (speculative IO process) when a speculative process is executed in a synchronous IO process.

A synchronous IO process when a speculative process is not executed may be executed by the following procedures (1) to (5), as illustrated in the upper part of FIG. 4.

(1) The application 2a issues an IO request for a data writing process (see the reference symbol A). Until receiving an instruction from the FS client 20, the application 2a stands by, in other words, waits for a response (see the reference symbol B). For example, the application 2a waits for the reception of a completion response of the IO process on the server 3 side to the IO request from the FS client 20 (i.e., synchronizes with the completion of the IO process).

(2) The FS client 20 receives the IO request from the application 2a and sends the IO request to the server 3 (see the Arrow A1).

(3) The server 3 executes the IO process on the storing region 3a on the basis the IO request received from the client 2 (see the reference symbol C), and transmits, upon completion of the IO process, a completion response of the IO process to the FS client 20.

(4) The FS client 20 receives the completion response from the server 3 and notifies the application 2a of the completion response (see Arrow C1).

(5) On basis of the completion response notified from the FS client 20, for example, a result indicative of a writing completion or a failure in writing, the application 2a resumes execution of the process suspended in the above (1) (see the reference symbol D).

On the other hand, the speculative IO process may be executed by the following procedures (11) to (15), as illustrated in the lower part of FIG. 4.

(11) The application 2a issues an IO request for a data writing process (see the reference symbol A). The application 2a also waits until receiving an instruction from the FS client 20. The FS client 20 obtains the IO request (see Arrow A2) and determines whether or not to execute a speculative process. If the speculative process is not executed, the FS client 20 controls the execution of a synchronous IO process when the speculative process is not executed. For example, the system 1 executes the procedures (2) to (5) described above.

(12) If the speculative process is executed, the FS client 20 generates a SS of the state (contents) of the storing region of the memory 10b (see FIG. 2) of the client 2 (see the reference symbol E). The FS client 20 transmits the IO request obtained from the application 2a to the server 3 (see Arrow A3).

(13) The server 3 executes the IO process on the storing region 3a on the basis the IO request received from the client 2 (see the reference symbol C), and transmits, upon completion of the IO process, a completion response of the IO process to the FS client 20.

(14) Upon generation of the SS, the FS client 20 instructs the application 2a to execute the speculative process (see Arrow E1). The FS client 20 may transmit a completion response of the IO request to the application 2a before the completion of the IO process (for example, in Arrow A2 or E1) or after completion of the IO process.

(15) Upon receipt of an instruction from the FS client 20 at Arrow E1, the application 2a resumes the execution of the process suspended in the above procedure (11) (refer to the reference symbol F) before the completion of the IO process, which means that the application 2a speculatively executes the process.

As described above, by executing a speculative process in the synchronous IO process, the FS client 20 can shorten the processing time of the application 2a, for example, the time from the issue of the IO request to the completion of the resumed process. In the example of FIG. 4, the time period indicated by the reference symbol G can be shortened by the speculative IO process.

<1-2> Example of Configuration of FS Client:

Next, description will now be made in relation to an example of the configuration of the above-described FS client 20. As illustrated in FIG. 3, the FS client 20 may include a monitoring unit 21, a determining unit 22, and a snapshot (SS) generating and restoring unit 23.

<1-2-1> Description of Monitoring Unit:

The monitoring unit 21 executes processing of the application 2a, a monitoring process of an IO request and the response, obtains various types of information relating to a speculative process, and accumulates (updates) the obtained information into the memory unit 2b. In addition, the monitoring unit 21 performs execution control of a speculative process on the application 2a.

The following procedures may be included in the execution control of a speculative process on the application 2a by the monitoring unit 21. For example, upon receipt of the completion response from the server 3 of the IO request transmitting destination, the monitoring unit 21 may control the continuation or interruption of the execution of the speculative process according to the content of the completion response. For example, the monitoring unit 21 continues the processing of the application 2a when the contents of the completion response indicates that the writing succeeded. On the other hand, when the contents of the completion response indicate a failure such as a writing error, the monitoring unit 21 aborts the execution of the speculative process and performs rewinding process that restores the contents of the storing region of the memory 10b from the SS in cooperation with the SS generating and restoring unit 23.

In the monitoring process, the monitoring unit 21 may obtain the speculative process execution time table 20a, the non-speculative process execution time table 20b, the execution time table 20c, and the average writing time table 20d, and store the tables 20a to 20d into the memory unit 2b.

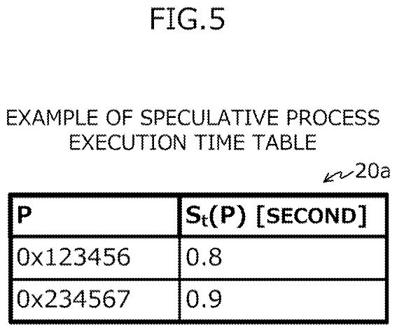

FIGS. 5 to 8 are diagrams illustrating examples of the speculative process execution time table 20a, the non-speculative process execution time table 20b, the execution time table 20c, and the average writing time table 20d.

As illustrated in FIG. 5, the speculative process execution time table 20a is information indicating an execution time Sₜ(P) (seconds) of a processing at each execution position P when a speculative process is executed.

The execution position P may be, for example, the address of the execution code of the application 2a (program) expanded on (stored in) the memory 10b.

The monitoring unit 21 may measure the time from the start to the end of execution of the execution code at the execution position P in the monitoring process during the execution of the speculative process, and store the measurement result (actual measurement value), as the execution time Sₜ(P), into the speculative process execution time table 20a.

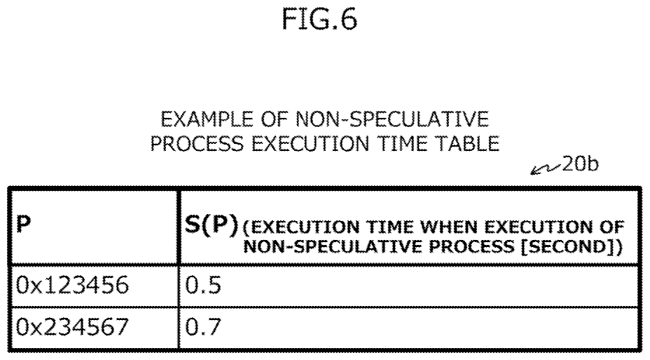

As illustrated in FIG. 6, the non-speculative process execution time table 20b is information indicating the execution time S(P) (seconds) of the processing for each execution position P when the speculative process is not executed.

The monitoring unit 21 may measure the time from the start to the end of execution of the execution code at the execution position P in the monitoring process when the speculative process is not executed, and store the measurement result (actual measurement value), as the execution time S(P), into the non-speculative process execution time table 20b.

To each of the above-described speculative process execution time table 20a and the non-speculative process execution time table 20b, an entry may be added each time measurement is made by the monitoring unit 21, and multiple entries may exist for the same execution position P.

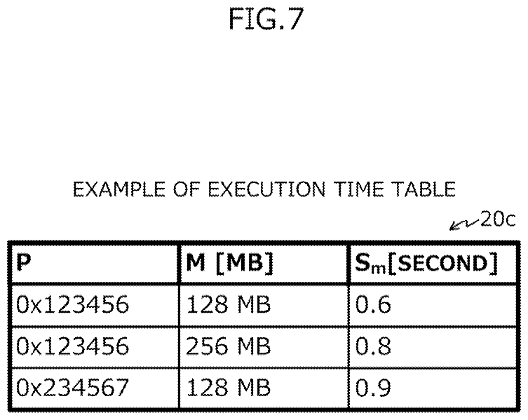

As illustrated in FIG. 7, the execution time table 20c when a SS memory is reserved is information indicating an execution time Sₘ (seconds) of a processing at each execution position P when a storing region having a size M (MB; Mega Byte) is reserved in the SS storage region 20e and a SS is obtained.

The monitoring unit 21 may measure the time from the start to the end of execution of the execution code at the execution position P when a SS is generated in the SS storage region 20e in the monitoring process during execution of a speculative process. Then the monitoring unit 21 may store the measurement result (actual measurement value) as the execution time Sₘ into the execution time table 20c in association with the execution position P and the size M of the SS.

Incidentally, to the execution time table 20c described above, an entry may be added each time measurement is made by the monitoring unit 21, and multiple entries may exist for the same number B of bytes.

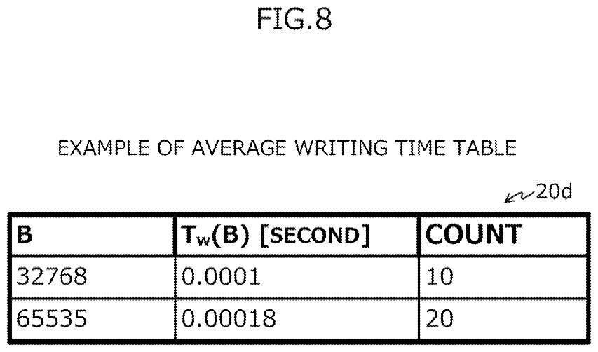

As illustrated in FIG. 8, the average writing time table 20d is information indicating an average processing time (average IO time) T_{w}(B) (seconds) when data of the given number B of consecutive bytes (B bytes) is written to the storage, for example, the server 3 (storing region 3a).

Each time an IO request is transmitted to the server 3 in the monitoring process, the monitoring unit 21 may measure the processing time of the IO processes relating to the IO requests in the server 3, and update the average value based on the measurement result (actual measurement value) and the average value of the existing entries for each B, which is the number of consecutive bytes. The update of the average value may be obtained, for example, by dividing a value of {(average value of the existing entry)×(count)+(measurement result)} by (count+1). The monitoring unit 21 may store the updated average value as an average processing time T_{w}(B) (seconds) into the average writing time table 20d in association with the number B of bytes and the updated count (count+1).

The update of the average writing time table 20d may be executed on the basis of, for example, a test workload executed at the time of starting the system 1 or the server 3 so as not to affect the processing during operation of the system 1. The average writing time table 20d may be generated in advance with reference to a performance table (specification sheet) of the system 1 or the server 3.

Furthermore, the monitoring unit 21 may obtain an average SS generation time T(P) (seconds) at an execution position P of the application 2a. For example, the monitoring unit 21 may measure and accumulate a SS generation time by the SS generating and restoring unit 23, which will be described below, for each execution position P, and calculate the average value for each execution position P as the average SS generation time T(P) based on the measurement result (actual measurement value).

The above-described information that the monitoring unit 21 obtains may be used for a determining process by the determining unit 22.

Incidentally, when an operation that would not be completed by the client 2 or the application 2a occurs in the speculative process executed by the application 2a, it is difficult to restore the state to one before the start of the speculative process by rewinding with a SS even if an IO process fails.

Examples of an operation that would not be not completed by the client 2 or the application 2a include writing to a storing device of the client 2 or an external device, and writing to a memory region referred by a program different from the application 2a.

As a solution to the above, for example, the monitoring unit 21 may limit the process targeted for a speculative process to a rewindable process. As an example, the monitoring unit 21 may exclude a process that satisfies a given condition from processes targeted for a speculative process. Examples of such a given condition are writing processes exemplified by a writing process on a storage device (e.g., a disk device, a non-volatile memory) and communication to an external device (network) different from the client 2.

As an example, in the case where a speculative process is executed, if detecting that the above writing process is included in processes to be performed in the speculative process through monitoring of variables of the execution codes of the application 2a during the monitoring process, the monitoring unit 21 may stop the speculative process. The position (execution position of the program) where the program is stopped may be, for example, any position from the start position of the speculative process to the above-described writing process.

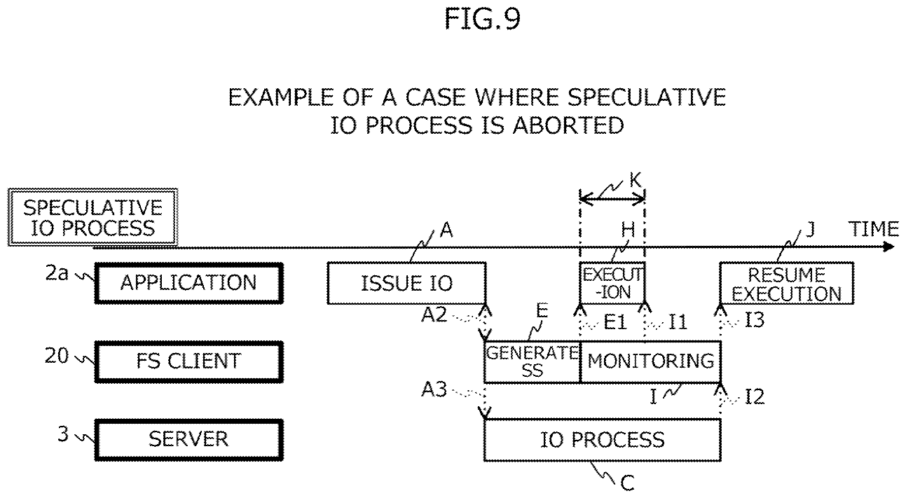

FIG. 9 is a diagram illustrating an example when a speculative IO process is aborted. For example, as illustrated in FIG. 9, after the generation of a SS (see the reference symbol E) is completed, the monitoring unit 21 instructs the application 2a to execute a speculative process (see Arrow E1). The monitoring unit 21 may monitor (see reference symbol I) the execution (see the reference symbol H) of the process by the application 2a, and if detecting that the above-described writing process is executed, instruct the application 2a to stop the speculative process (see Arrow I1).

For example, by issuing a stopping instruction, the monitoring unit 21 may cause the application 2a to suspend the execution of the process until receiving the completion response of the IO process from the server 3 (see Arrows I2 and I3) and resume the execution of the process after receiving the completion response (see the reference symbol J). In this case, the execution period of the application 2a from the start to the stop of the speculative process (see Arrow K) is the execution period of the speculative process.

This makes it possible to reduce the possibility that an operation which cannot be restored by rewinding of the SS is executed in the speculative process.

Besides, the monitoring unit 21 may execute the following procedures (a) to (e) when, for example, detecting that a writing process into a “memory region” except for the storing regions of the memory 10b reserved after the execution of the speculative process is executed in the course of the monitoring process performed when the speculative process is executed.

(a) The monitoring unit 21 sets to restrict writing into the memory region, as an example, sets the permission of the memory region to “reading only”.

(b) The monitoring unit 21 adds the stored contents in the memory region to the target for a SS to be generated by the SS generating and restoring unit 23.

(c) The monitoring unit 21 sets a flag indicative of “only writable” for the memory region.

(d) The monitoring unit 21 waits for a completion of the writing process by the application 2a while executing the speculative process.

(e) When the execution of the speculative process is canceled (completed), the monitoring unit 21 returns the permission of the memory region to the original state.

As described above, the monitoring unit 21 inhibits another program except for the application 2a from, while the speculative process is being executed, referring to the memory region and executing a process on the basis of the referring result.

This makes it possible to reduce the possibility that an operation which cannot be restored by rewinding of the SS is executed in the speculative process.

In cases where another program attempts to access the memory region and a protection violation error occurs, the monitoring unit 21 may catch the error and control the other program to stand by until the execution of the speculative process is completed and to resume the processing after the execution is completed.

<1-2-2> Description of SS Generating and Restoring Unit:

The SS generating and restoring unit 23 generates a SS of the contents of the storing region of the memory 10b and restores the contents of the storing region from the SS to the memory 10b.

For example, the SS generating and restoring unit 23 may generate a SS of the contents of the storing region of the memory 10b in response to an instruction from the determining unit 22, and store the generated SS in the SS storage region 20e. This can record the state of the memory 10b at the time point when the SS is generated. The range of obtaining a SS may be, for example, a storing region allocated to the application 2a among the storing regions of the memory 10b. The generation of a SS may be implemented by various known methods.

Furthermore, the SS generating and restoring unit 23 may restore (store) the contents of the SS stored into the SS storage region 20e to the storing region of the memory 10b in response to an instruction from the monitoring unit 21. This makes it possible to rewind the state of the memory 10b to that at the time point when the SS is generated.

Furthermore, the SS generating and restoring unit 23 may discard the contents of the SS stored in the SS storage region 20e by, for example, managing the region of the SS storage region 20e which region is storing the SS to be freeable in response to an instruction from the monitoring unit 21. An examples of a case of discarding the SS is cases where the completion response of the IO process received from the server 3 indicates normal termination, in other words, in cases where the restoring processing (rewinding) from the SS becomes unnecessary.

<1-2-3> Description of Determining Unit:

The determining unit 22 determines whether or not to execute a speculative process on the basis of the information obtained by the monitoring unit 21.

For example, the determining unit 22 may determine whether or not the processing time of the application 2a in regard of a writing process of B bytes at an execution position P of the application 2a is shortened by execution of a speculative process (whether or not the speculative process is effective to shorten the processing time).

When determining that the execution of a speculative process shortens the processing time of the application 2a, the determining unit 22 may instruct the SS generating and restoring unit 23 to generate a SS, and may notify the monitoring unit 21 that the speculative process is to be executed.

As an example, the determining unit 22 may determine that the execution of a speculative process shortens the processing time of the application 2a (determine that a speculative process is to be executed) if the processing time X when the speculative process is performed is less than the processing time Y when the normal synchronous IO process is executed (i.e., when the speculative process is not executed).

The processing time Y of the normal synchronous IO process may be calculated by the determining unit 22 according to the following Expression (1).

processing time Y=S(P)+T_{w}(B) (1)

In the above Expression (1), the term S(P) is the execution time S(P) of the entry at the execution position P in the non-speculative process execution time table 20b, that is, the execution time of the resuming processing when the speculative process is not executed. The term T_{w}(B) is the average processing time T_{w}(B) of an entry corresponding to the writing data size B specified in the IO request in the average writing time table 20d.

As described above, in the example of the synchronous IO process illustrated in the upper part of FIG. 4, the processing time Y of the normal synchronous IO process is the sum of the processing time (T_{w}(B)) of the IO process (the reference symbol C) and the processing time (S(P)) of resuming of execution (the reference symbol D).

The processing time X when the speculative process is executed may be calculated by the determining unit 22 according to the following Expression (2).

Processing time X=max(T(P)+S(P)*S_{sp_avg}(P)⁻¹*S_{m_avg}(P,M)⁻¹,T_{w}(B)) (2)

In the above Expression (2), the term max(α,β) is a function that outputs an expression having a large value between the expressions α and β. The term T(P) is an average SS generation time T(P) at the execution position P of the application 2a calculated by the monitoring unit 21.

In the above Expression (2), the term S_{sp_avg}(P) is an indicator indicating a performance decline ratio of the performance of a speculative IO process that executes a speculative process to the performance of a synchronous IO process that does not execute a speculative process. An example of the “performance” includes an execution time, but is not limited to this. The performance may alternatively be an execution speed or the like. In this alternative, the term S_{sp_avg}(P) may be, for example, the average speed decline ratio when the application 2a executes the speculative process from the execution position P. The performance decline when a speculative process is executed may occur, for example, due to overhead of the monitoring process or the like.

As described above, the term S_{sp_avg}(P) is an example of a first indicator relating to a performance decline ratio when the first process is executed before the application 2a receives a completion response of an IO process to the IO request instead of being executed after the application 2a receives the completion response.

In the above Expression (2), the term S_{m_avg}(P,M) is an example of a second indicator indicating a performance decline ratio of a performance at each execution position P when a SS is obtained after reserving a storing region having a size M in the SS storage region 20e in a speculative IO process to the performance of a synchronous IO process that does not execute a speculative process. The term S_{m_avg}(P,M) may be, for example, a performance decline ratio when a storing region of the SS having a size M is separately reserved (stored) from the execution position P. Decline of a performance when a SS is stored into the SS storage region 20e may occur, for example, when the memory 10b used as the SS storage region 20e is occupied by the SS and therefore the processing speed of the client 2 declines.

As described above, the term S_{m_avg}(P,M) is an example of a second indicator relating to a performance decline ratio when a SS of a storing region (memory region) of the memory 10b at a time point that the IO request is transmitted is generated, the memory region storing an execution code of the application 2a.

That is, the term “S(P)*S_{sp_avg}(P)⁻¹*S_{m_avg}(P,M)⁻¹” in the above Expression (2) represents execution time of a speculative process.

Thus, in the above Expression (2), the expression corresponding to α of the term max (α,β) is the sum of the processing time (T(P)) of generation of the SS (the reference symbol E) and the processing time (S(P)*S_{sp_avg}(P)⁻¹*S_{m_avg}(P,M)⁻¹) of the speculative process (the reference symbol F) in the example of the speculative IO process illustrated in the lower part of FIG. 4.

The processing time X when the speculative process is executed is the larger one of the above-mentioned time corresponding to a of max(α,β) and the processing time (T_{w}(P)) of the IO process (see reference symbol C in the lower part of FIG. 4) corresponding to β of max(α,β).

Here, the term S_{sp_avg}(P) in the above expression (2) may be a value in the range from “0” to “1” both inclusive, and for example, S_{sp_avg}(P)=“0.7” means that the performance decline by “30%” occurs by executing the speculative process. The term S_{sp_avg}(P) may be calculated by the determining unit 22 according to the following Expression (3).

S_{sp_avg}(P)=[Average value of Sₜ(P)]/[Average value of S(P)] (3)

In the above Expression (3), the average value of the values of Sₜ(P) is the average value of the values of one or more Sₜ(P) associated with the same execution position P in the speculative process execution time table 20a. The average value of the values of S(P) is the average value of the values of one or more S(P) associated with the same execution position P in the non-speculative process execution time table 20b.

Further, the term S_{m_avg}(P,M) in the above Expression (2) may be a value in the range from “0” to “1” both inclusive. The term S_{m_avg}(P,M) may be calculated by the determining unit 22, for example, according to the following Expression (4).

S_{m_avg}(P,M)=[average value of Sₘ(P,M)]/[Average value of S(P)] (4)

In the above Expression (4), the average value of the value of Sₘ(P,M) is the average value of the value of one or more Sₘ(P,M) associated with the same execution position P and the same size M in the execution time table 20c.

In this manner, when the application 2a transmits the IO request, the determining unit 22 determines whether or not to execute a speculatively executable process (speculative process), which is an example of the first process, before the application 2a receives the completion response, on the basis of S_{sp_avg}(P) and S_{m_avg}(P,M). If the determining unit 22 determines to execute the first process before the completion response is received, the SS generating and restoring unit 23 generates a SS of the storing region, and the monitoring unit 21 causes the application 2a to start execution of the first process.

As described above, when the processing time X when the speculative process is executed is less than the processing time Y of the normal synchronous IO process, the FS client 20 can shorten the processing time by the difference of the processing time Y (minutes) from the processing time X (minutes) (i.e., Y−X).

Further, when the processing time X when the speculative process is executed is equal to or longer than the processing time Y of the normal synchronous IO process, the determining unit 22 may determine to execute the synchronous IO process which does not include a speculative process because the speculative IO process does not contribute to shortening of the processing time of the application 2a.

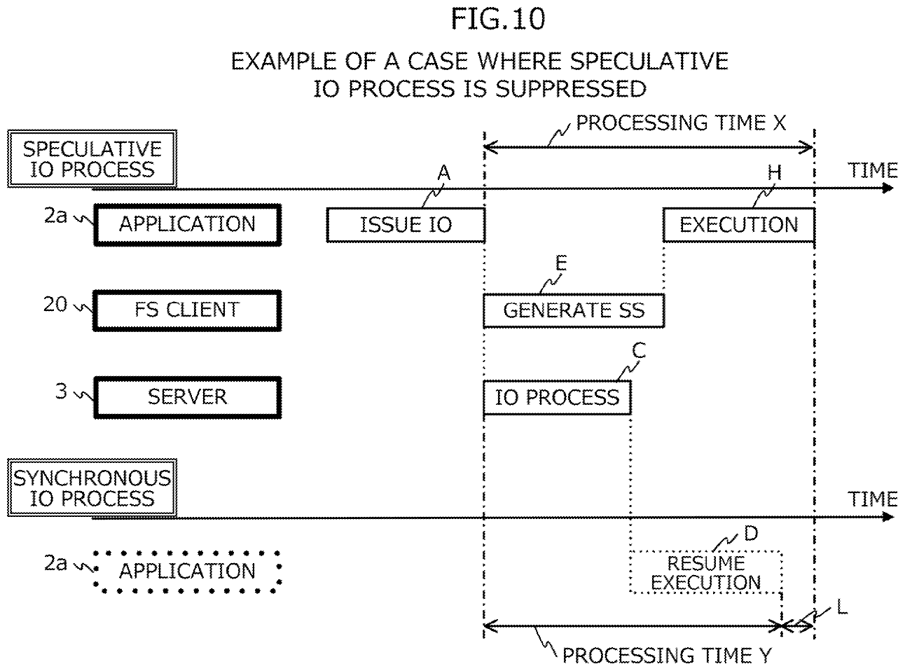

FIG. 10 is a diagram illustrating an example when a speculative IO process is suppressed. FIG. 10 illustrates a case where the processing time X is larger than the processing time Y by the period indicated by Arrow L. In this case, the processing time when the application 2a resumes the execution of processing (see the reference symbol D) after the synchronous IO process indicated by a dashed line which means after the completion of the IO process (see the reference symbol C) is shorter by time L minutes than that when a speculative IO process is executed.

Therefore, since the FS client 20 can determine whether or not to execute the speculative process on the basis of the estimated value of the processing time, it is possible to enhance the probability of shortening the processing time of the synchronous IO process.

Incidentally, in addition to the processing described above, the determining unit 22 may determine whether or not to execute the speculative process on the basis of determination on at least one of the following (i) and (ii).

(i) For example, when the sum of the average SS generation time T(P) and the product of the rewinding occurrence probability F of the speculative process and the restoring time from the SS is shorter than the IO processing time (write guarantee time) in the server 3, the determining unit 22 may determine to execute the speculative process.

The rewind occurrence probability F may also be referred to as a failure probability of an IO process (writing processing) in the server 3. For example, the monitoring unit 21 may measure the failure probability of the IO process in the server 3 and use the average value of the measurement results as the rewinding occurrence probability F, or may obtain the rewinding occurrence probability F with reference to the performance table of the server 3. The rewinding occurrence probability F may be a value in a range from “0” to “1” both inclusive.

The restoring time from the SS is a time that the SS generating and restoring unit 23 requires to restore the contents of the storing region of the memory 10b from the SS in the SS storage region 20e. For example, the monitoring unit 21 may measure the restoring time from the SS and obtain the average value of the measurement results.

This can reduce the possibility that the overhead of the generating time of the SS and the restoring time from the SS when the speculative process is performed becomes equal to or longer than the IO process time by the writing guarantee, so that the processing time of the IO process can be shortened.

(ii) The determining unit 22 may measure an indicator indicating the influence of the volume consumed in the storing region of the memory 10b by generation of the SS on the system performance of the client 2, and may suppress the execution of the speculative process when the performance decline amount based on the measured indicator exceeds the merit of the speculative process.

As the indicator, for example, S_{m_avg}(P,M) in the above Expression (2) may be used. The merit of the speculative process may be evaluated using, for example, S_{sp_avg}(P) in the above Expression (2) or the average value of the value of Sₜ(P) in the above Expression (3).

As a result, when the speculative process is executed, it is possible to reduce the possibility that the processing speed of the client 2 declines due to the exclusive use of the memory region by the SS, and the effect of shortening the processing time by the speculative process is eliminated, so that the processing time of the IO process can be shortened.

By the process performed by the determining unit 22 described above, the FS client 20 can shorten the processing time of the synchronous IO process by the amount of “(the time required for the writing guarantee)+(the processing time of the executable speculative process)−[{(the success ratio of the speculative process)*(the execution time of the speculative process)}+(SS generation time)]”.

<1-3> Example of Operation:

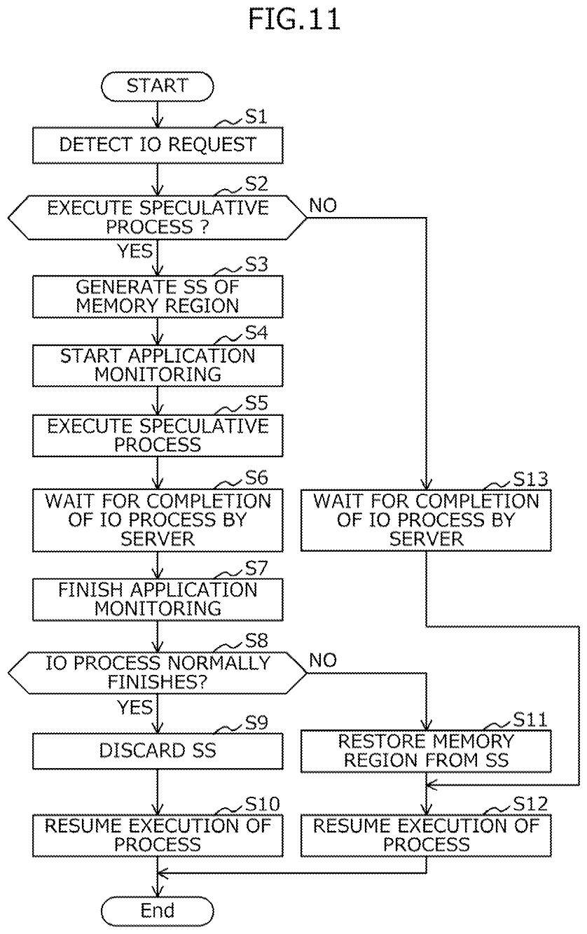

Next, description will now be made in relation to an example of operation of the client 2 in the system 1 according to the one embodiment with reference to FIG. 11. FIG. 11 is a flow diagram illustrating an example of operation of the client 2.

As illustrated in FIG. 11, in the client 2, the monitoring unit 21 of the FS client 20 detects the generation of an IO request by the application 2a (Step S1), transmits the IO request to the server 3, and notifies the determining unit 22 of the generation of the IO request.

The determining unit 22 determines whether or not to execute a speculative process on the basis of information being measured by the monitoring unit 21 in the past and being stored in the memory unit 2b (Step S2).

If determining to execute the speculative process (YES in Step S2), the determining unit 22 instructs the SS generating and restoring unit 23 to generate a SS. In response to the instruction from the determining unit 22, the SS generating and restoring unit 23 generates a SS of the memory region that the application 2a uses (Step S3), and stores the generated SS into the SS storage region 20e.

In addition, the determining unit 22 instructs the monitoring unit 21 to start the monitoring process. After the generation of the SS is completed, the monitoring unit 21 starts the monitoring process on the application 2a (Step S4) and instructs the application 2a to execute the speculative process.

The application 2a executes the speculative process in response to the instruction from the monitoring unit 21 (Step S5).

The monitoring unit 21 waits for the completion response of the IO process from the server 3 (Step S6).

Upon receipt of the completion response, the monitoring unit 21 terminates the monitoring process on the application 2a (Step S7), and determines whether or not the IO process is normally completed on the basis of the completion response (Step S8).

If determining that the IO process is normally completed (YES in Step S8), the monitoring unit 21 instructs the SS generating and restoring unit 23 to discard the SS.

The SS generating and restoring unit 23 discards the SS stored in the SS storage region 20e (Step S9).

The application 2a resumes (continues) the execution of a process following the speculative process (Step S10), and the process ends.

In step S8, if determining that the IO process has ended abnormally (error) (NO in Step S8), the monitoring unit 21 instructs the SS generating and restoring unit 23 to restore the memory region from the SS.

The SS generating and restoring unit 23 restores the memory region of the memory 10b from the SS stored in the SS storage region 20e (Step S11).

In accordance with the execution code on the restored memory region, the application 2a resumes execution of the processing from the state before the execution of the speculative process (Step S12), and the process ends.

In Step S2, if determining not to execute the speculative process (NO in Step S2), the determining unit 22 instructs the monitoring unit 21 to execute a synchronous IO process that does not execute a speculative process.

In the synchronous IO process, the monitoring unit 21 causes the application 2a to suspend the execution of processing and waits for the completion response of the IO process from the server 3 (Step S13).

Upon receipt of the completion response of the IO process from the server 3, the monitoring unit 21 instructs the application 2a to resume the processing. In response to an instruction from the monitoring unit 21, the application 2a resumes the execution of the suspended processing (Step S12), and the process ends.

### <2> Miscellaneous

The technique according to the one embodiment described above can be implemented by changing or modifying as follows.

For example, the monitoring unit 21, the determining unit 22, and the SS generating and restoring unit 23 of the FS client 20 illustrated in FIG. 3 may be merged or divided in any combination.

The information 20a to 20d stored in the memory unit 2b illustrated in FIG. 3 may be merged or divided in any combination.

In one aspect, the processing time of an IO process can be shortened.

Throughout the specification, the claims, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer readable recording medium having stored therein a control program that causes a computer to execute a process comprising:
when an application transmits an input-output (IO) request,
determining whether or not to execute a first process before the application receives a completion response of an IO process to the IO request instead of executing the first process after the application receives the completion response, the determining being based on a first indicator and a second indicator, the first indicator relating to a performance decline ratio when the first process is executed before the application receives the completion response, the second indicator relating to a performance decline ratio when a snapshot of a memory region at a time point that the IO request is transmitted is generated, the memory region storing an execution code of the application; and
when determining to execute the first process before the application receives the completion response,
generating the snapshot of the memory region, and
causing the application to start execution of the first process.

2. The non-transitory computer readable recording medium according to claim 1, the process further comprising:
when determining to execute the first process before the application receives the completion response,
monitoring, based on the execution code in the memory region, the first process that the application is caused to start; and
when the monitoring detects a process satisfying a given condition in the first process,
aborting the first process being executed before the application receives the completion response.

3. The non-transitory computer readable recording medium according to claim 2, wherein the aborting comprises:
discarding the snapshot; and
causing the application to resume the first process being aborted after the application receives the completion response.

4. The non-transitory computer readable recording medium according to claim 2, the process further comprising:
obtaining, in the monitoring, an execution time that the application takes to execute the first process; and
storing, as information used for calculating the first indicator, the obtained execution time in association with an execution position of the execution code.

5. The non-transitory computer readable recording medium according to claim 2, the process further comprising:
obtaining, in the monitoring, an execution time that the application takes to execute the first process when the snapshot is stored in a storing region different from the memory region; and
storing, as information used for calculating the second indicator, the obtained execution time in association with a data size of the snapshot.

6. The non-transitory computer readable recording medium according to claim 1, wherein
the first indicator represents, for each execution position of the executing code of the application, a decline ratio of an execution time for the first process being started before the application receives the completion response to an execution time for the first process being executed after the application receives the completion response; and
the second indicator represents, for each size of the snapshot, a decline ratio of the execution time for the first process being started before the application receives the completion response to the execution time for the first process being executed after the application receives the completion response.

7. The non-transitory computer readable recording medium according to claim 1, the process further comprising:
when the application starts the execution of the first process before receiving the completion response notifying a failure of the IO process,
restoring, from the snapshot, the memory region at the time point that the IO request is transmitted; and
causing the application to start the first process, using the restored memory region.

8. An information processing apparatus comprising:
a memory; and
a processor coupled to the memory, the processor being configured to:
when an application transmits an input-output (IO) request,
determine whether or not to execute a first process before the application receives a completion response of an IO process to the IO request instead of executing the first process after the application receives the completion response, the determining being based on a first indicator and a second indicator, the first indicator relating to a performance decline ratio when the first process is executed before the application receives the completion response, the second indicator relating to a performance decline ratio when a snapshot of a memory region at a time point that the IO request is transmitted is generated, the memory region storing an execution code of the application; and
when determining to execute the first process before the application receives the completion response,
generate the snapshot of the memory region, and
cause the application to start execution of the first process.

9. The information processing apparatus according to claim 8, wherein the processor is further configured to:
when determining to execute the first process before the application receives the completion response,
monitor, based on the execution code in the memory region, the first process that the application is caused to start; and
when the monitoring detects a process satisfying a given condition in the first process,
abort the first process being executed before the application receives the completion response.

10. The information processing apparatus according to claim 9, wherein the processor is further configured to:
discard the snapshot; and
cause the application to resume the first process being aborted after the application receives the completion response.

11. The information processing apparatus according to claim 9, wherein the processor is further configured to:
obtain, in the monitoring, an execution time that the application takes to execute the first process; and
store, as information used for calculating the first indicator, the obtained execution time in association with an execution position of the execution code.

12. The information processing apparatus according to claim 9, wherein the processor is further configured to:
obtain, in the monitoring, an execution time that the application takes to execute the first process when the snapshot is stored in a storing region different from the memory region; and
store, as information used for calculating the second indicator, the obtained execution time in association with a data size of the snapshot.

13. The information processing apparatus according to claim 8, wherein
the first indicator represents, for each execution position of the executing code of the application, a decline ratio of an execution time for the first process being started before the application receives the completion response to an execution time for the first process being executed after the application receives the completion response; and
the second indicator represents, for each size of the snapshot, a decline ratio of the execution time for the first process being started before the application receives the completion response to the execution time for the first process being executed after the application receives the completion response.

14. The information processing apparatus according to claim 8, wherein the processor is further configured to:
when the application starts the execution of the first process before receiving the completion response notifying a failure of the IO process,
restore, from the snapshot, the memory region at the time point that the IO request is transmitted; and
cause the application to start the first process, using the restored memory region.

15. A computer-implemented method for controlling, the computer-implemented method comprising:
when an application transmits an input-output (IO) request,
determining whether or not to execute a first process before the application receives a completion response of an IO process to the IO request instead of executing the first process after the application receives the completion response, the determining being based on a first indicator and a second indicator, the first indicator relating to a performance decline ratio when the first process is executed before the application receives the completion response, the second indicator relating to a performance decline ratio when a snapshot of a memory region at a time point that the IO request is transmitted is generated, the memory region storing an execution code of the application; and
when determining to execute the first process before the application receives the completion response,
generating the snapshot of the memory region, and
causing the application to start execution of the first process.

16. The computer-implemented method according to claim 15, further comprising:
when determining to execute the first process before the application receives the completion response,
monitoring, based on the execution code in the memory region, the first process that the application is caused to start; and
when the monitoring detects a process satisfying a given condition in the first process,
aborting the first process being executed before the application receives the completion response.

17. The computer-implemented method according to claim 16, further comprising:
discarding the snapshot; and
causing the application to resume the first process being aborted after the application receives the completion response.

18. The computer-implemented method according to claim 15, wherein
the first indicator represents, for each execution position of the executing code of the application, a decline ratio of an execution time for the first process being started before the application receives the completion response to an execution time for the first process being executed after the application receives the completion response; and
the second indicator represents, for each size of the snapshot, a decline ratio of the execution time for the first process being started before the application receives the completion response to the execution time for the first process being executed after the application receives the completion response.

19. The computer-implemented method according to claim 15, further comprising:
when the application starts the execution of the first process before receiving the completion response notifying a failure of the IO process,
restoring, from the snapshot, the memory region at the time point that the IO request is transmitted; and
causing the application to start the first process, using the restored memory region.
